(19) United States
(12) Patent Application Publication
(10) Pub. No.: US 2009/0047650 A1
(43) Pub. Date: Feb. 19, 2009

(54) SYSTEM FOR OPERATING EDUCATIONAL WEBSITE FOR PROMOTING PARENT AND TEACHER INVOLVEMENT

(76) Inventors: Daniel Pierce Leuck, Honolulu, HI (US); John C. Bower, Honolulu, HI (US); Brett Seitman, Aiea, HI (US)

Correspondence Address: LEIGHTON K. CHONG;PATENT ATTORNEY, 133 KAAI STREET, HONOLULU, HI, 96821, US

(21) Appl. No.: 12/192,070

(22) Filed: Aug. 14, 2008

Related U.S. Application Data
(60) Provisional application No. 60/956,383, filed on Aug. 16, 2007.

(51) Int. Cl. G09B 3/00

(52) U.S. Cl. 434/350

(57) ABSTRACT

A system for operation of an educational website on a network offers curriculum content provided by one or more curriculum content providers for engagement of student users on the website. The website includes webpages accessible by the students, by a teacher for a class of students registered to use the website, and by parents registered along with their students. An awards scoring component scores the performance of individual student users and awards them award points, which can be redeemed for rewards on the website. The website includes a component for communicating information about student user performance to their teacher and parents in order to promote parent and teacher involvement with students' activities on the website.

### TECHNICAL FIELD

This invention generally relates to a web platform that augments educational programs offered by online curriculum providers by providing incentives for academic performance and promoting greater teacher and parent involvement.

### BACKGROUND OF INVENTION

There have been many educational websites that attempt to motivate students to engage with educational materials presented as games and other fun activities so that they can enhance their learning or reinforce what they have been taught in school. When students play games or other activities offered on educational websites, they are commonly awarded points or tokens to measure their progress. Often the points and awards are made redeemable for discounts, prizes, or other promotions in order to incentivize students to return to the website frequently and explore the full menu of activities provided on it. The offering of discounts, prizes, or promotions also provides channels for commercial vendors to become sponsors of the website in order to advertise their products and services and create commercial goodwill with young audiences who may become future buyers of their products and services.

However, educational websites have had the shortcoming that they do not generally involve parents or teachers in the student's activities on such websites. The operators of such websites may view parental or teacher involvement as an inhibitor to a student's desire to explore and engage in play with the materials offered on the websites. Consequently, the teachers' classroom curricula are not integrated with the curriculum materials presented on the websites. Parents who are not involved tend to view such websites with suspicion as commercial advertising intended to exploit their children.

### SUMMARY OF INVENTION

In accordance with the present invention, a system for operation of an educational website on a network offers curriculum content provided by one or more curriculum content providers for engagement of student users on the website, and webpages accessible by students, by a teacher for a class of students registered to use the website, and by parents registered along with their students. An awards scoring component scores the performance of individual student users and awards them award points, which can be redeemed for rewards on the website. The website includes a component for communicating information about student user performance to their teacher and parents in order to promote parent and teacher involvement with students' activities on the website.

In general, the system provides a web platform that interacts with end users via a web application, small desktop applications known as widgets, mobile applications, and email. It facilitates interactions with partners and users in a variety of ways, including through the website (web application), desktop widgets, mobile applications, and email. It also enables interaction with rewards partners and curriculum providers via web services APIs.

The web platform allows multiple curriculum providers to interact with a generalized “plug and play” points-based incentives program, in contrast to prior programs created by a single curriculum provider for offering only their own content. The invention system facilitates an ecosystem of rewards partners and curriculum providers which can interact through a common web platform.

In the preferred embodiment of an educational website, the system enables integrated student, teacher, sponsor/vendor, and parental involvement with students' activities on an educational website. It augments online curriculum and other academically motivated activities by providing and managing point awards that can be used to “purchase” items from a catalog. It provides for student/parent involvement using a variety of techniques including email messages to parents to announce student achievements and to provide metrics for parents to gauge their student's progress on the website. The website system can also be used to enable social networking features to enhance interactions between students on the websites.

To enable teachers, parents, and students to interact with the system and with each other, desktop and web widgets are provided in conjunction with user interfaces for the system to facilitate non-intrusive but appropriate interactions among the different types of users. The system transparently manages the interactions between students, teachers, parents, rewards partners, and curriculum providers in the background so that the interactions seem non-intrusive. External websites and commercial systems integrate with the educational website system through industry-standard web services supporting interaction between software systems, or by simple file transfer for less technically sophisticated partners.

Other objects, features, and advantages of the present invention will be explained in the following detailed description with reference to the appended drawings.

### BRIEF DESCRIPTION OF DRAWINGS

FIG. 1 illustrates a preferred embodiment of a functional architecture of the educational website system in accordance with the present invention.

FIG. 2A shows a screen shot of an entry page to a test a student can take on the website, FIG. 2B shows a screen shot of a student landing page, FIG. 2C shows a screen shot of a teacher landing page, FIG. 2D shows a screen shot of a class registration page, FIG. 2E shows a screen shot of a parent registration page, FIG. 2F shows a screen shot of a student score reporting page for a specific test, FIG. 2G shows a sample of an email message to a teacher reporting students scores for a specific test, FIG. 2H shows a screen shot of the teacher webpage reporting students scores for a specific test, and FIG. 2I shows an example of a Parent Desktop Widget to facilitate parental involvement in student activities on the educational website.

FIG. 3 shows the use case of the Student Parent Interaction: Desktop Widget Scenario.

FIG. 4 shows the use case of the Student Parent Interaction: Web Application Scenario.

FIG. 5 shows the use case of the Student Parent Interaction: Email to Web Application Scenario.

FIG. 6 shows the use case for Student ParentPeer interaction via web messaging.

FIG. 7 shows an intelligent rewards catalog system for managing rewards offered by one or more rewards Partners.

FIG. 8 illustrates the process for adding Parent-created rewards to the rewards catalog.

FIG. 9 shows an example of a Student Mailbox page which lists messages they have received from their Teacher, Parents(s), and Peers.

FIG. 10 shows an example of a Student Award Points page which lists as an incentive the Student's total points earned, recently earned points, and other points notification messages.

### DETAILED DESCRIPTION OF INVENTION

In the following detailed description, certain preferred embodiments are described as illustrations of the invention in a specific application, network, or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The term “Internet” is intended to include any wide area digital network or network of networks connecting a universe of users via a common or industry-standard (TCP/IP) protocol. Users having a connection to the Internet commonly connect browsers on their computing terminal or device to websites that provide informational content via web servers. The Internet can also be connected to other networks using different data handling protocols through a gateway or system interface, such as wireless gateways using the industry-standard Wireless Application Protocol (WAP) to connect Internet websites to wireless data networks. Wireless data networks are now deployed worldwide and allow users anywhere to connect to the Internet via wireless data devices.

Where used in the specific context of the presently described educational website system, the term “curriculum provider” refers to an external entity that provides online curriculum presented on or accessed through the educational website. Curriculum providers can participate with the educational website system either by hosting curriculum on their own website and communicating results to the present website using a web services API, or by using the curriculum hosting function on the present system. In either case, the system is fully automated. A curriculum provider could also provide courses via shipped media (such as DVDs) and communicate results to any application running on a system with an internet connection. Curriculum providers could also offer completely offline activities where the results (attended/didn't attend) are reported “manually” by the activity leader using the web application interface.

The term “rewards partner” refers to an external entity that provides discounts, prizes, and/or promotions (generally “awards”) which are purchasable with reward points earned on the present website system. Rewards partners can provide their inventories of awards (“catalogs”) via a bulk upload and/or web services interaction with the present website system.

The term “uBoost System” refers to the engine at the heart of the overall educational website system that operates the educational website by presenting hosted curriculum materials for student play and awards, and that enables the various integrated website functions, such as enabling teachers, students, and parents to view students' current award points (uBoost currency), to purchase items with award points, to view performance reports, and to send each other messages. The term “uBoost Web Messaging” refers to features of the uBoost website that employ desktop widgets that allow manual and/or automated messaging between parties (parents, students and teachers) in an organized, safe and secure manner using an email-like web interface. “uBoost Widgets” are mini-applications that provide a condensed version of the functionality provided in the Web Messaging application above.

### Functional Architecture of Educational Website System

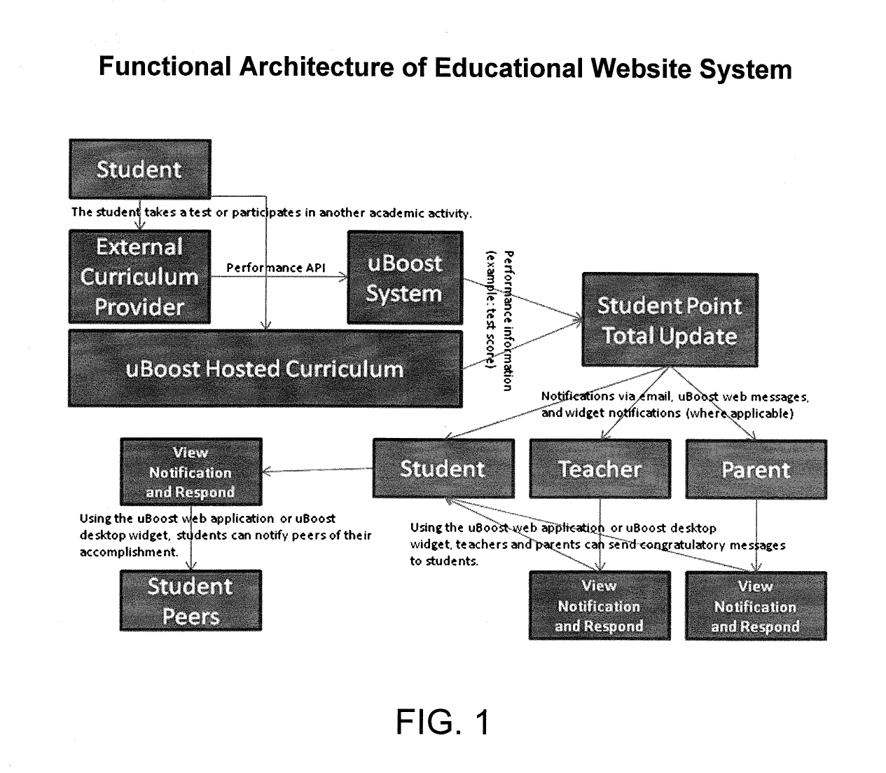

Referring to FIG. 1, the functional architecture of the educational website system is illustrated showing how the uBoost System is the engine that operates the educational website and enables its various integrated website functions with the other components referenced in the figure (in initial capital letters). Based on the expected Student educational levels and achievement goals, the External Curriculum Provider provides curriculum content via a Performance API into the uBoost System, which becomes the uBoost Hosted Curriculum. Upon accessing the website, the Student takes a test or participates in another academic activity of the uBoost Hosted Curriculum, and the Performance Information (e.g., Student score) is retained in the Student Point Total Update database component.

The Student Point Total Update sends notifications via email, uBoost web messages, or widget notifications (where applicable) to the Student, Teacher, and Parent. The Student can view the notification and respond by using the uBoost web application or Student Desktop Widget to communicate with their peers about their point totals or in various social networking functions such as trading points or collaborating on rewards. The Teacher and Parent can view their respective notifications and respond by using the uBoost web application or Teacher or Parent Desktop Widget to communicate with the Student or each other by sending congratulatory messages, or messages of appreciation such as where Student points or Parent-matching gifts have added to Teacher or Classroom points.

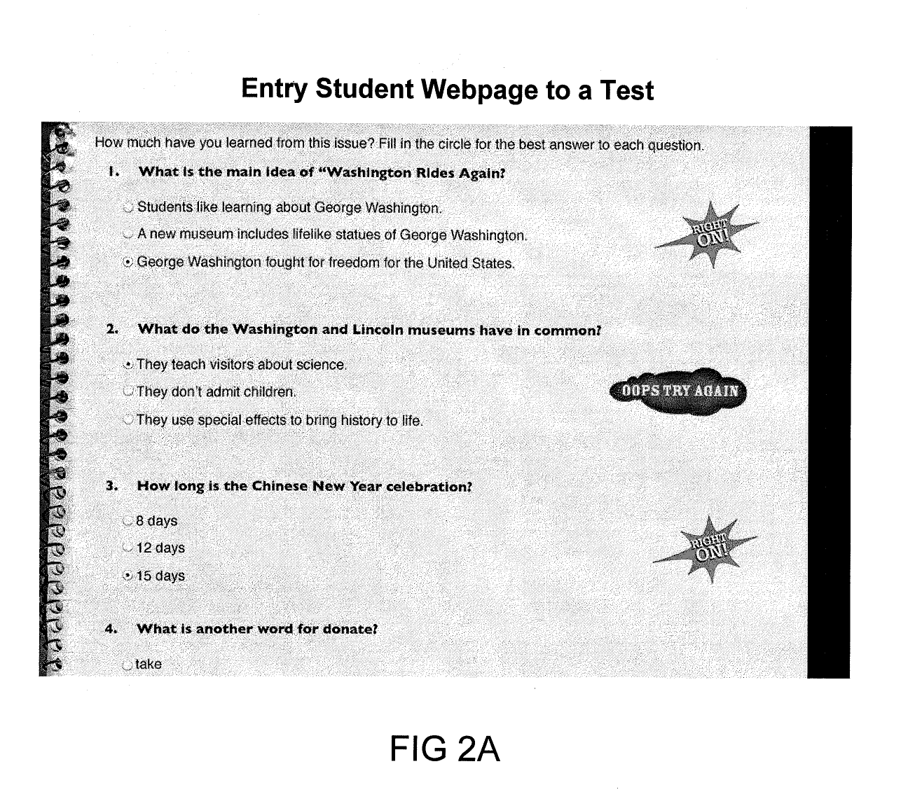

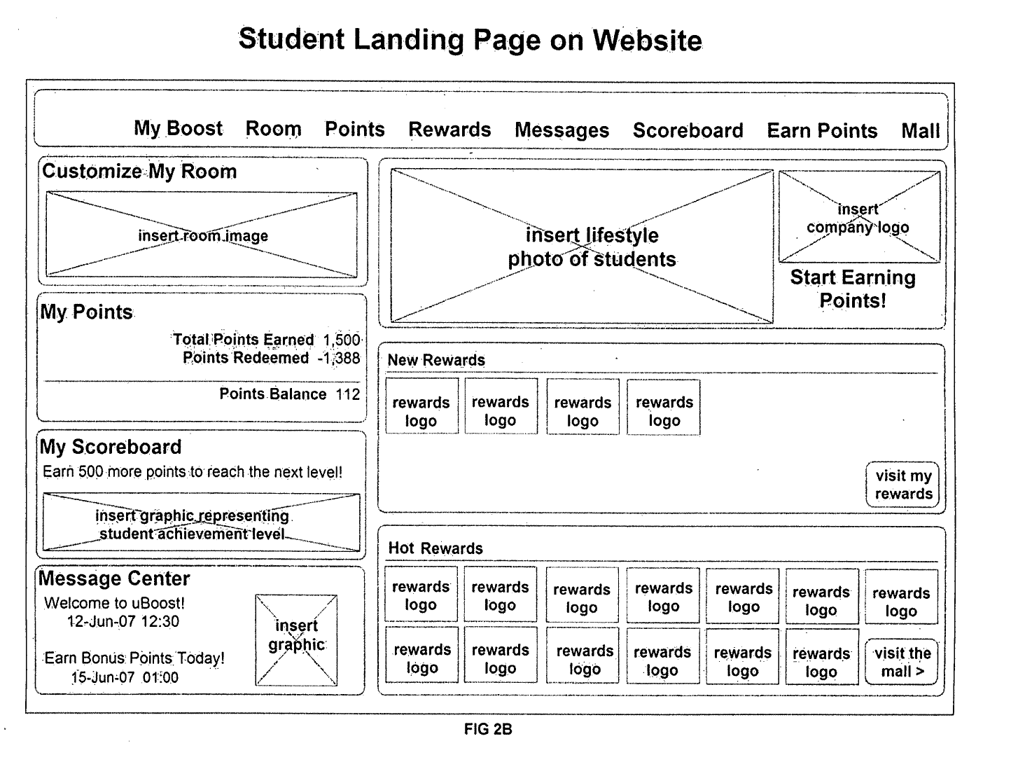

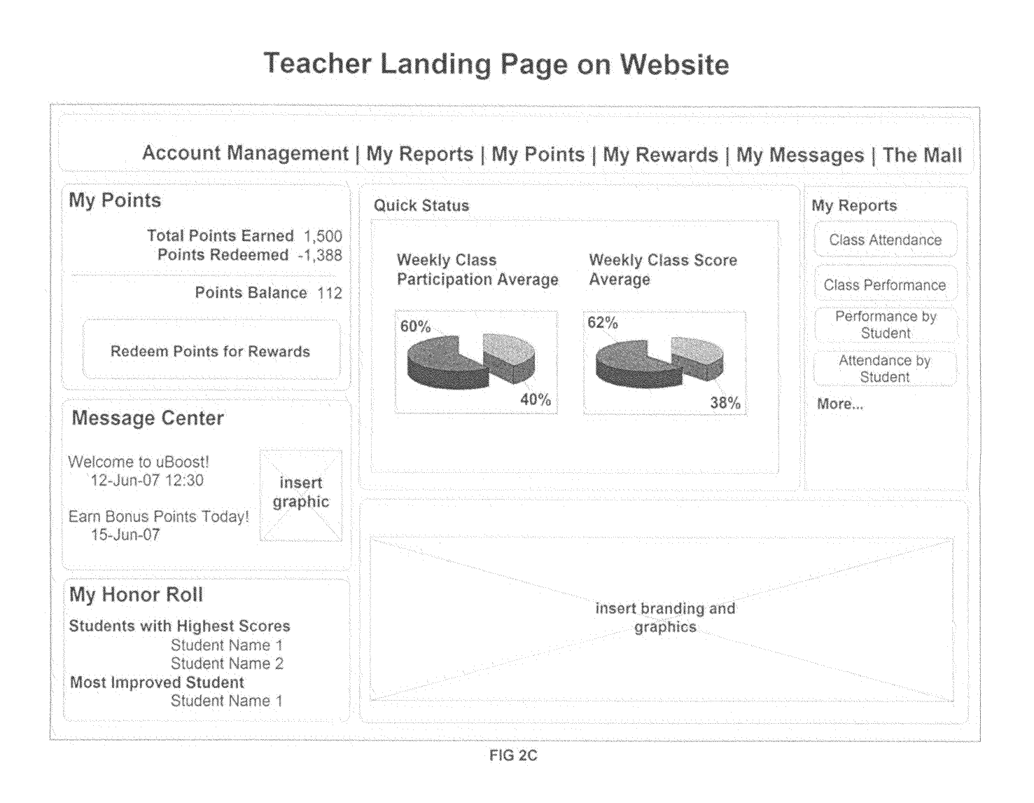

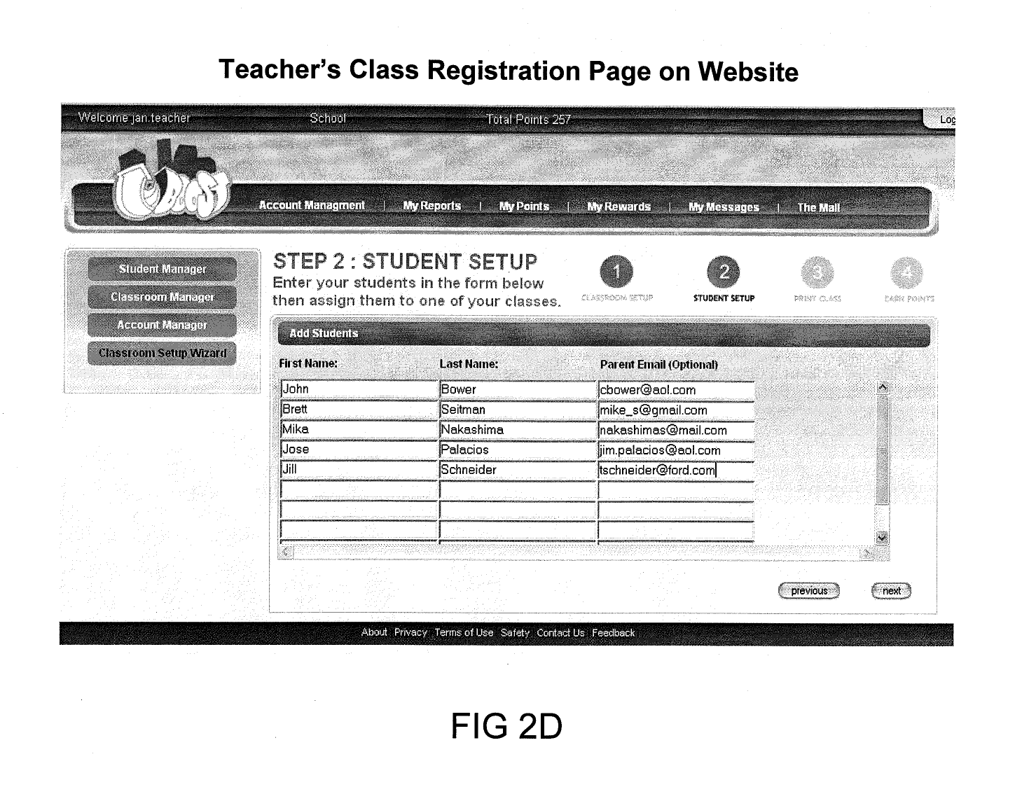

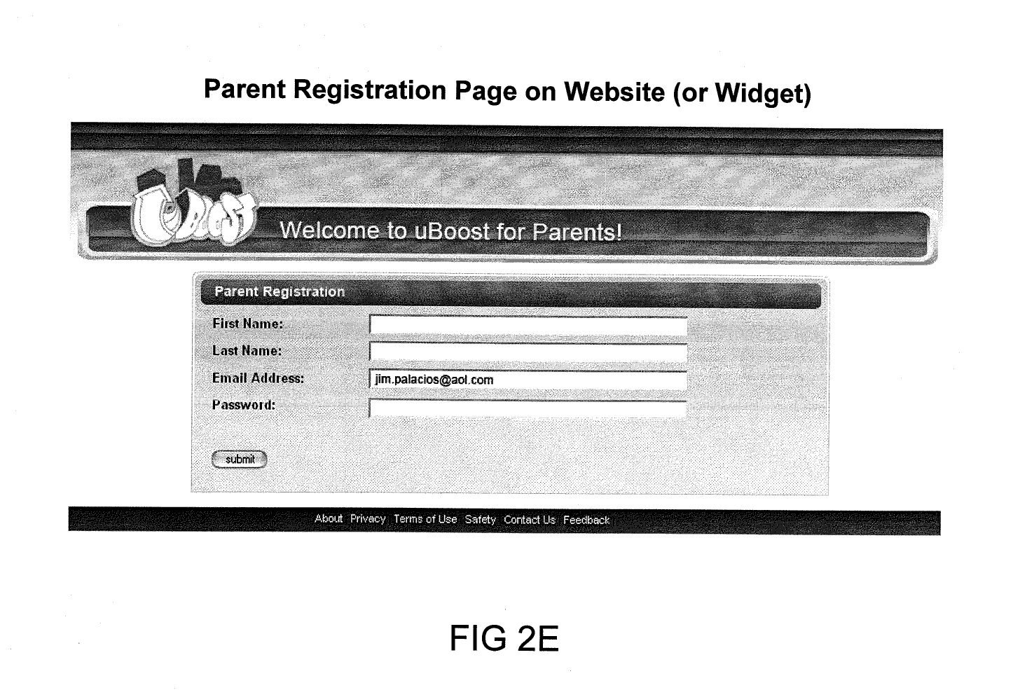

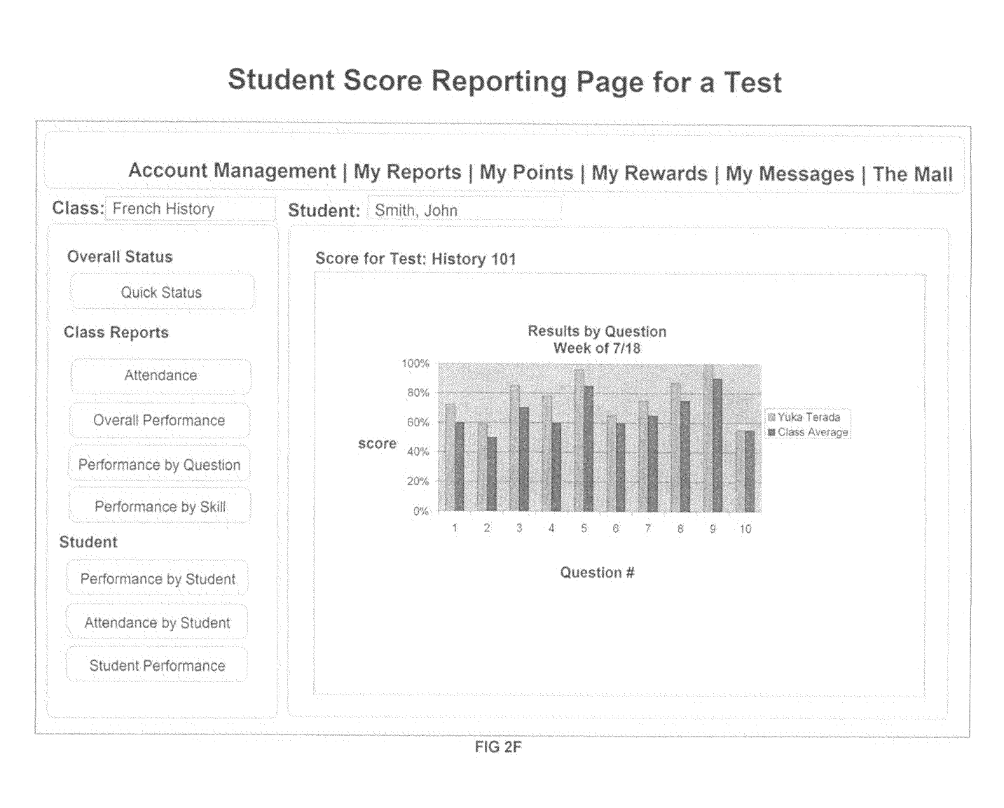

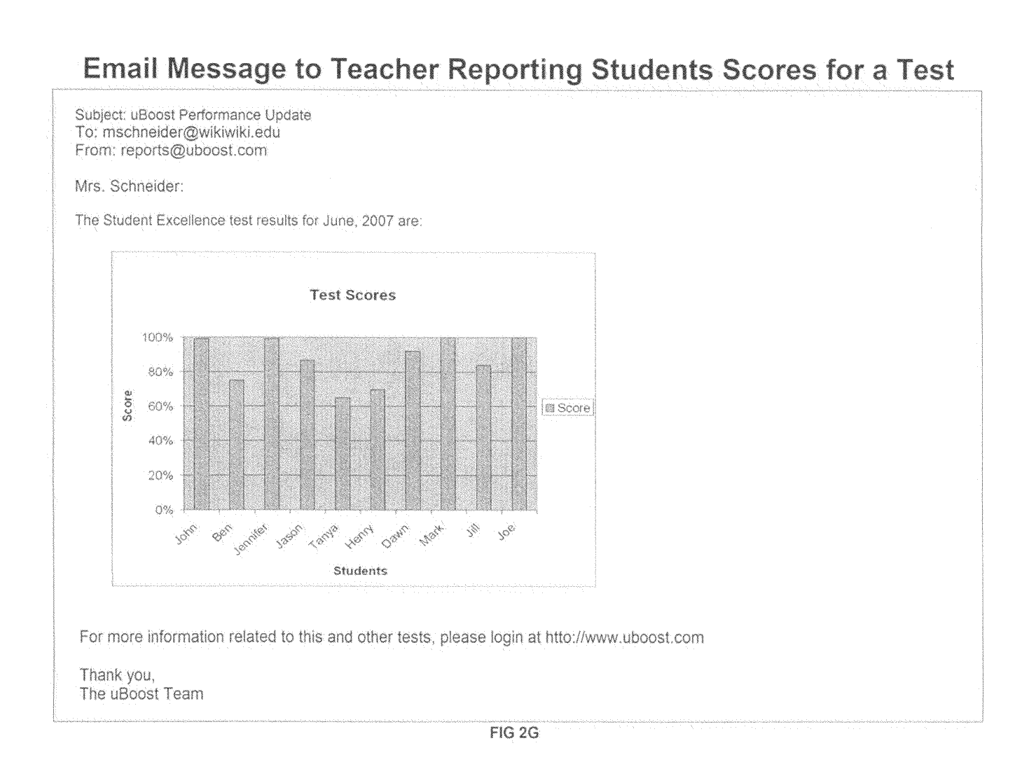

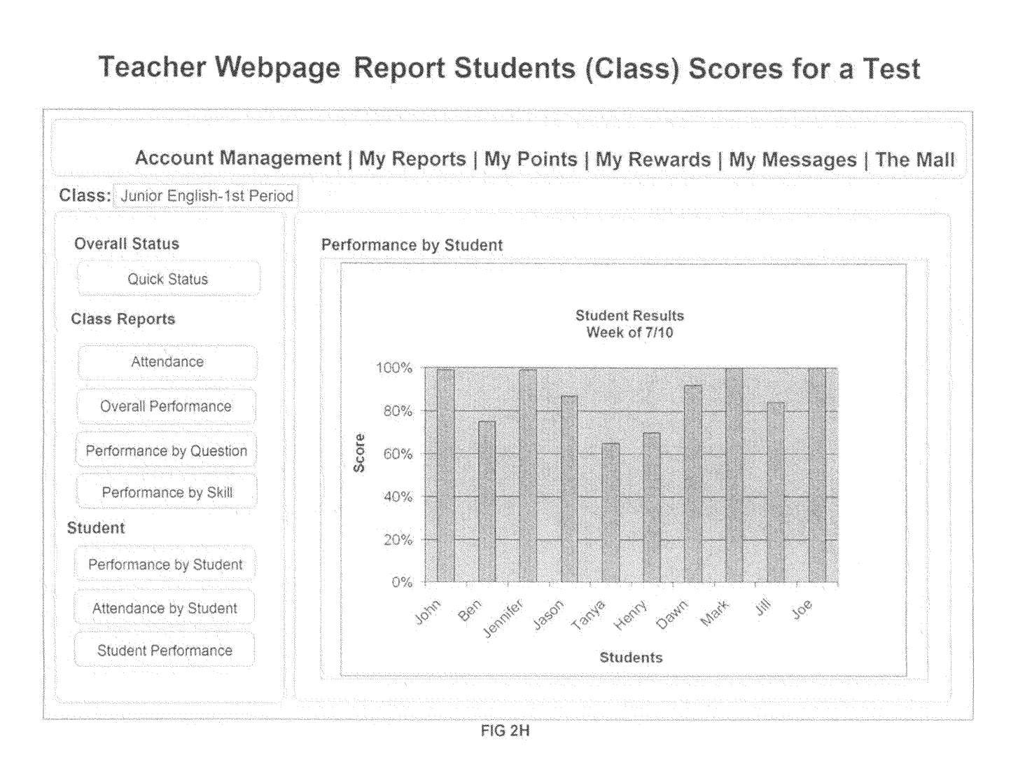

In FIG. 2A, an example is shown of an entry webpage to a test a student can take on the website. FIG. 2B shows an example of a student landing page on the website with a navigation bar, student points account displays, student messaging display, and student awards earning and redemption displays. FIG. 2C shows an example of a teacher landing page on the website, with navigation bar (including selection of class), teacher/class points account displays, teacher messaging display, and teacher reports displays. FIG. 2D shows an example of a class registration page, which allows the teacher to set up a registration list for students in a class with parent email address (option). FIG. 2E shows an example of a parent registration page on the website (or through the parent desktop widget). FIG. 2F shows an example of a student score reporting page for a specific test. FIG. 2G shows an example of an email message to a teacher reporting students scores for a specific test. FIG. 2H shows an example of the teacher webpage reporting students scores for a specific test. FIG. 2I shows an example of a Parent Desktop Widget to facilitate parental involvement in student activities on the educational website. It includes enabling the Parent to send the Student feedback with a supportive message such as the “Send Note” link. The Widget can be downloaded to a Parent's PC or mobile device to conveniently pop-up messages from the Student or Teacher and send messages back.

### Operation of Educational Website

A preferred embodiment for an educational website incorporating the above-described functional architecture of the educational website system will now be described. Processes are described of sequences of actions to be performed by Users and other entities as part of the system's expected operation. These Users and entities play specific Roles within the described Processes.

As used in the following description, the term “Partners” refers to companies or community organizations which are designated as sponsors on the website and/or offer specific awards to specific student groups, parents and teachers for achieving specific objectives.

“Teachers”, as an adjunct to their classroom teaching, act to register the Students as Users of the educational website and oversee the student's activities on the website in tandem with their classroom performance. Teachers are key communicators in the rewards program(s) ensuring that students' time and activities on the website are appropriate and that the awards system serve the purpose of engaging the Students and is not misused. Through computerized functions performed by electronic scripts from a curriculum provider's program or the uBoost System on the website, Teachers are relieved of the need to authenticate scores and verify whether a student has met the requirement for a reward.

“Parents”, as an adjunct to parental care of the Student, will be involved in the program through a feedback loop of communication functions automated or facilitated for ease of use. This keeps the Parent aware of the Student's activities on the website, and makes it convenient for the Parent to provide quick feedback to encourage the Student's performance and use of the website.

“Students”, in addition to their performance in classes, are registered by their Teachers to become Users of the website, and their Parent(s) are kept apprised of the Student's activities and rewards for completing educational or other tasks on the website.

“Reward Claimant” is a User, most often a Student, who claims a reward or other award indicia (voucher, coupon, etc.) for redemption from a Partner through specified channels (online stores, physical restaurants or stores, etc) or through a fulfillment system. Rewards can be awarded to and redeemed by not only Students, but also Teachers and even Parents.

“Customer” of the educational website system is typically a curriculum partner which hosts or provides curriculum content (tests, games, activities) for access via the educational website system. A Customer is typically a developer/provider of educational curriculum for access through any channel (off-line, on-line, or in a mobile context).

“System Administrator” is responsible for the maintenance and configuration of the educational website system and its infrastructure. These responsibilities may include the following: customer support (point issues, reward redemption issues, fulfillment, communication with student, teacher, parent); system administration (to keep the system up and running at all times); data integration and reporting mechanism for teachers, parents and customers; managing content of reports and communications to teacher, parent, student, reward partner, etc.

“System Platform” includes all the software, hardware, data components, etc., of the educational website system.

Teacher and Student Registration: As part of the initial marketing of the system to a class, school, educational district, etc., Teachers will be encouraged to enroll themselves and their class as Users of the educational website. An email invitation may be sent to Teachers to click a link to a landing page on the website. Teachers may be offered an incentive for registering their Students, such as award points for the class which may be redeemed for rewards or items that benefit the class as a whole. The Teacher will be prompted on-screen to enter Student screen names and general information of importance to use of the system, and the website privacy policies for use of non-personally-identifying data will be explained. The registration of a class may include a free trial period, followed by an ongoing class subscription at an affordable rate. Teachers will be able to view this information from within the web application. Their landing webpage will be provided with a class administration interface that can include updates of usernames and/or passwords, e-mail address changes and new curriculum content. The Teacher's landing page will also allow teachers to have access to past and present class reports and content. The system will also provide the Teacher with confirming information that identifies the school, class, and curriculum content on the website that Teacher is using in tandem with activities in the classroom.

Partner and Prize Registration: A Partner will negotiate a deal with the website system to offer certain rewards, prizes, and/or purchasable or redeemable gifts on the website, subject to the website's applicable terms and conditions. The Partner will provide a Registration Form containing the required information. The website system will also register the Rewards being offered by the Partner in the system, by entering a name and description of the award they will offer, as well as images and any other associated media. The data may be transmitted as an upload file formatted to the website's Rewards database requirements. An Inventory of Rewards offered will be maintained, and an Inventory level indicator will be set to show the current status of items the Partner wishes to offer as Rewards. As a convenient confirmation function, the system will test the new Rewards inventory via a bot/script that runs when a new Partner is added or periodically to test display of the prizes offered. Once the testing is completed successfully, the system sets the Rewards status to “Visible”, making it visible in the appropriate catalog of available rewards.

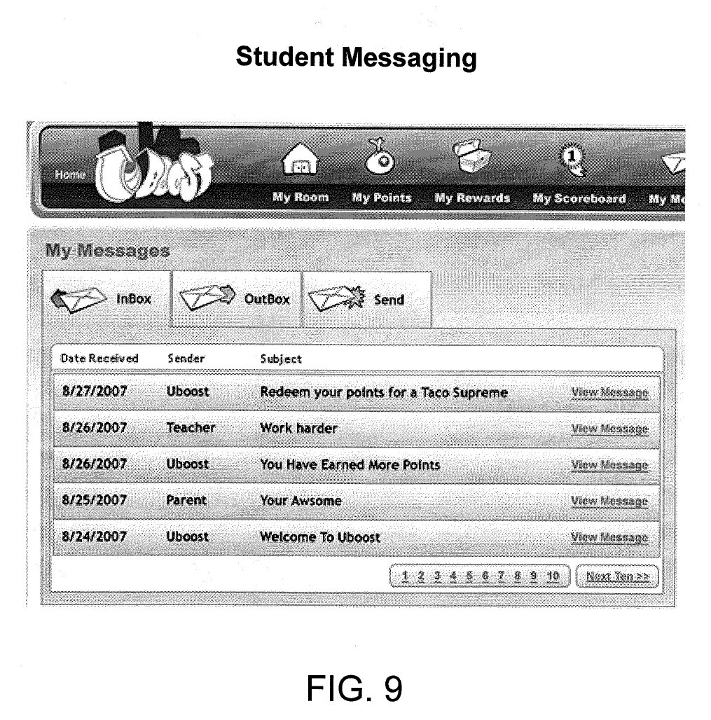

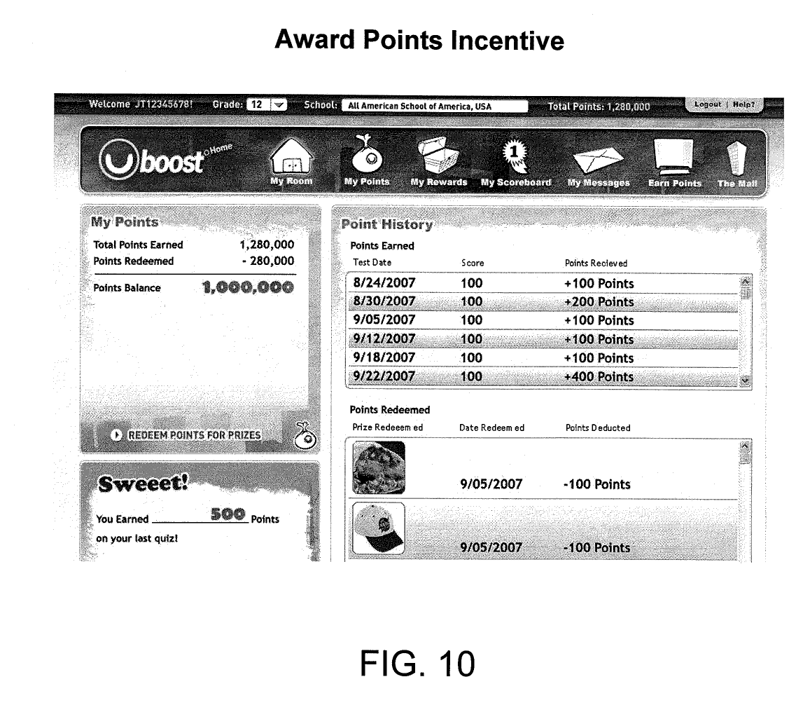

Usage by Students: The first time a Student logs in to the website, a welcome screen will display a description of the website offerings, content, and rewards program(s). A message will also be displayed urging the Student to ask their parent(s) to register, either by accessing the website or through the Teacher's class registration interface, and offering an incentive to the Student and/or Teacher for Parent registration. Upon registration, a Flash-based presentation will show the Student how to use the website. In subsequent accesses, the Student's log-in webpage will display their current points earnings, enable links to the curriculum partner and to the prize catalog(s), and other items. The Student webpage may include a Mailbox page which lists messages they have received from their Teacher, Parents(s), and Peers (see example in FIG. 9). Various functions may be implemented to engage frequent usage by the Student of the website and to utilize the rewards program(s) as incentive. FIG. 10 shows an example of a Student Award Points page which lists the Student's total points earned, recently earned points, and other points notification messages. Students may also be provided with an incentive to earn points for referring a friend to register as Peers. Students may be offered a desktop widget to download on their computers that will pop-up messages from the system and offer a convenient link to their landing page.

Usage by Teachers: The first time a Teacher logs in to the website, a welcome message will appear in the Teacher Console thanking the teacher for registering their students, and will provide a brief overview of the system functions. The Teacher will be prompted to set certain default settings including dashboard options for their landing page. The Teacher will be given options on how they would like recognition messages to be sent to Parents. Incentives may be offered to Teachers to urge Students and Parents to register the whole class. In subsequent usages, a menu on the Teacher's Console provides standard links to available reports the Teacher has requested or set defaults to receive. Various notification messages may be displayed for the Teacher's attention, as well as a listing of messages waiting in their Mailbox.

Usage by Parents: Parent registration may be accomplished by the parent accessing the website or by the Teacher through the class registration interface. The first time a registered Parent logs in to the website, a welcome screen will display a description of the website offerings, content, and rewards program(s). The Student(s) that the Parent is linked to (as entered or noted during registration) is/are displayed on the Parent's webpage. In subsequent usages, the Parent's webpage will also provide links to reports on their child's points earnings, and notification messages for the Parent's attention, as well as a listing of messages waiting in their Mailbox. Parents may be offered a desktop widget to download on their computers that will pop-up messages from the system and offer a convenient link to their landing page.

Earning & Redeeming Award Points: The educational website system tracks all points earning events, consults rules to determine applicable point multipliers, calculates points earned by applicable multipliers, and updates Students, Teacher, and Parents award points accounts in real time. Multipliers may be assigned by the system based on Class level, Accomplishment level (or activity type), Reward Status (low, medium, high), and other relevant factors. Awarded points are the initial unmodified awards from the sources enumerated above. Calculated points are the awarded points times the multipliers. The system may be configured to apply different multipliers based on curriculum level or accomplishment above expected curriculum level. If there are multiple curriculum Partners participating in the same website program offered to that class, school, or district; the awards available for each of the different programs will be displayed on separate tabs. Within a tab, the awards are filtered to those that the Customer (curriculum provider) has set as acceptable awards. The Student can view the catalog of available rewards to make their selections. Each item in the Awards Catalog may have a “Redeem Now” button active if the Student has enough available points to redeem the reward (the button is grayed out if the Student does not). Upon clicking the “Redeem Now” button, the website system displays a screen that congratulates the Student, and a coupon code and associated instructions for claiming the reward. Some prizes may be delivered via e-coupons that may be printed out. If the reward is redeemed, the system will then decrement the appropriate amount of points from the Student's account.

System Reports: Most system reports are updated in real time, so they are always up to date. These include points earned, accrued, and claimed, comparative scores between classes, rewards claimed by item, vendor, category, class, gender, grade, school, district, etc., reports requested by respective participants, and any other reports that may provide value to participants of the educational website system. Backend processes may be used for reports that are computationally intensive such as computing district, state and national averages. The reports provide information on performance by state, district, school, class, and student including test performance by skill category. These reports include student performance over time and against averages (national, state, district, school and class).

### Examples of Use Cases

The following describes use cases by which the educational website system in the present invention can facilitate interactions between Students, Teachers, and Parents via the uBoost System so as to obtain teacher and parental involvement in student activities on the educational website. The first three use cases show scenarios for interactions between Students and Parents via Desktop Widgets, Web Application, and E-Mail. The same scenarios may be similarly applied for interactions between Students and Teachers. The fourth use case is for interactions between Students and Parent/Peer via web messaging.

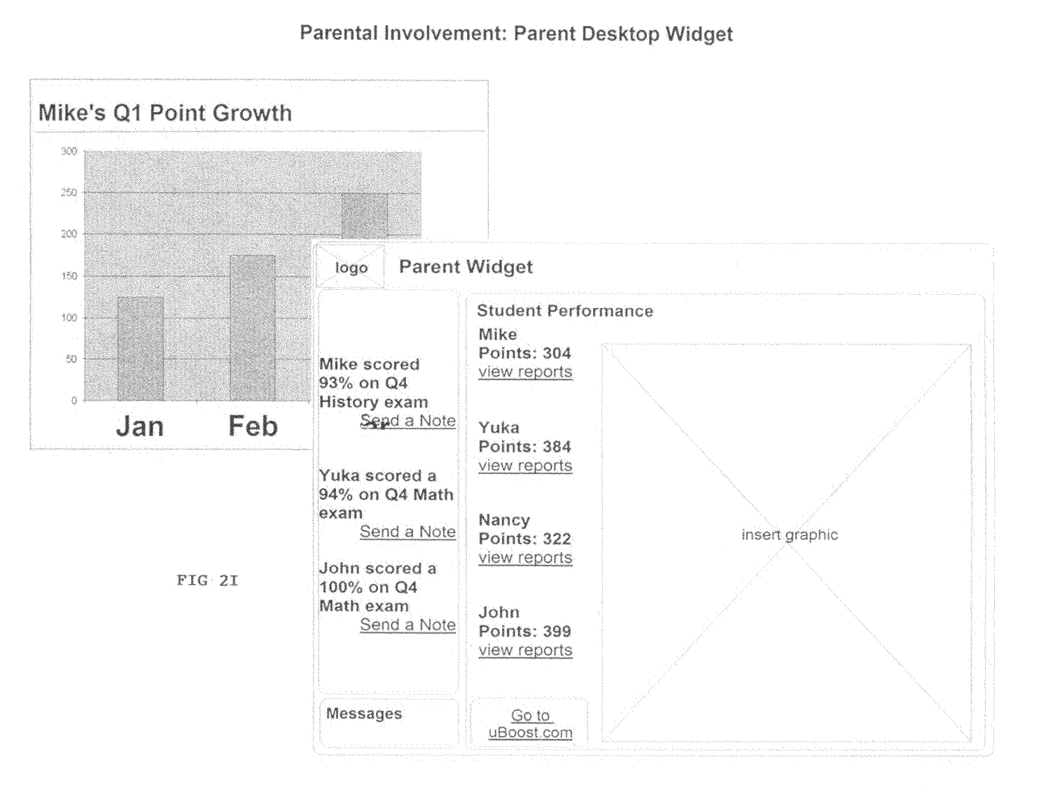

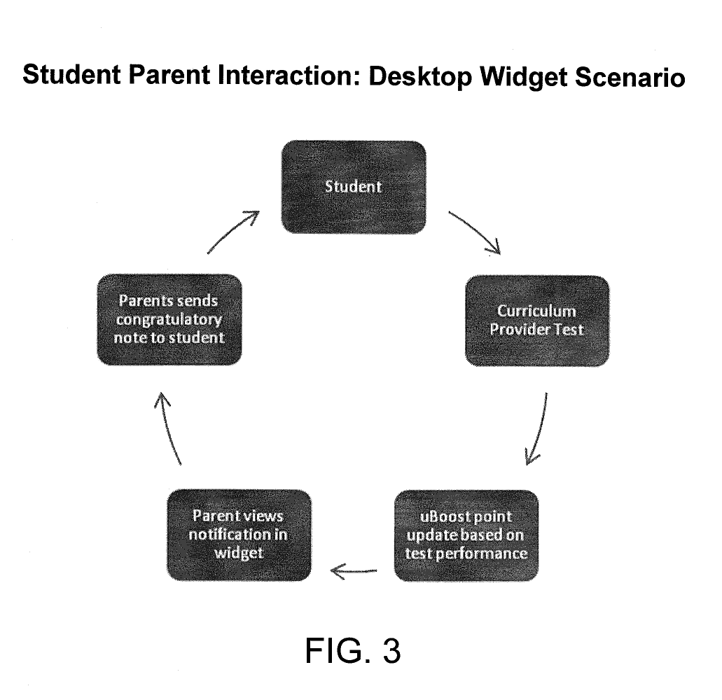

FIG. 3 shows the use case of the Student Parent Interaction: Desktop Widget Scenario. The scenario encompasses the following sequence of events:

(1) The Student takes a test of an External Curriculum Provider (e.g., takes an online test on the website or at an external website of the External Curriculum Provider such as www.acmelearningcompany.com/nature/animal_kingdom/test).

(2) After the Student completes the test, the curriculum provider's system automatically communicates the performance information to the uBoost System using the uBoost web services API.

(3) The uBoost System updates the students point total based on the performance information.

(4) A message box pops up on the Parent Desktop Widget notifying them of the accomplishment.

(5) The Parent clicks on the “Send Note” link in the desktop widget (see FIG. 2) and sends a congratulatory note to the Student, which they can view in the web messages area of their web interface.

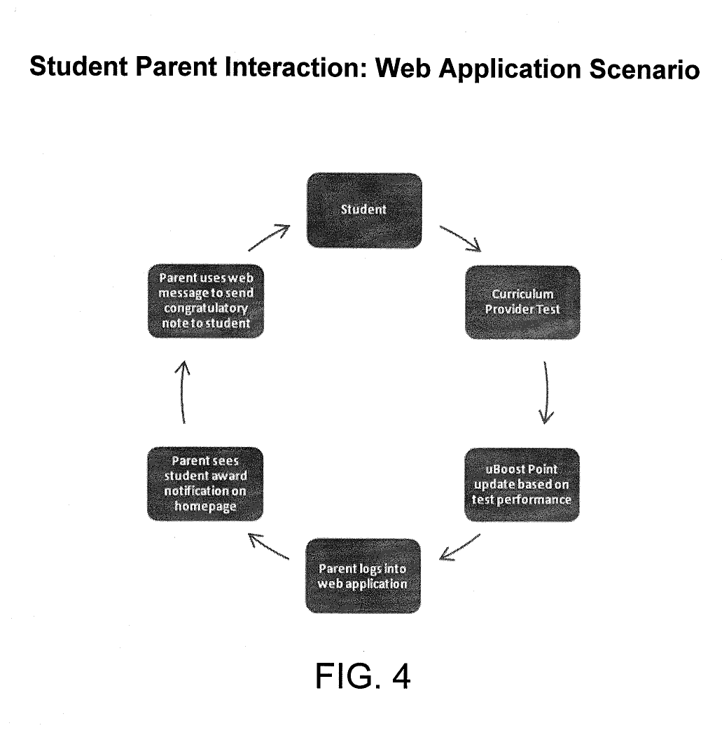

FIG. 4 shows the use case of the Student Parent Interaction: Web Application Scenario:

(1) The Student takes a test provided by an External Curriculum Provider.

(2) After the Student completes the test, the curriculum provider's system automatically communicates performance information to the uBoost System using the uBoost web services API.

(3) The uBoost System updates the students point total based on the performance information.

(4) The next time the Parent logs into the uBoost System via the website, they see the student point award notification on the homepage.

(5) The Parent can click on the “Send Note” link next to the notification message on the homepage interface and send a congratulatory message to the Student, which they can view in their web messages area on the uBoost website.

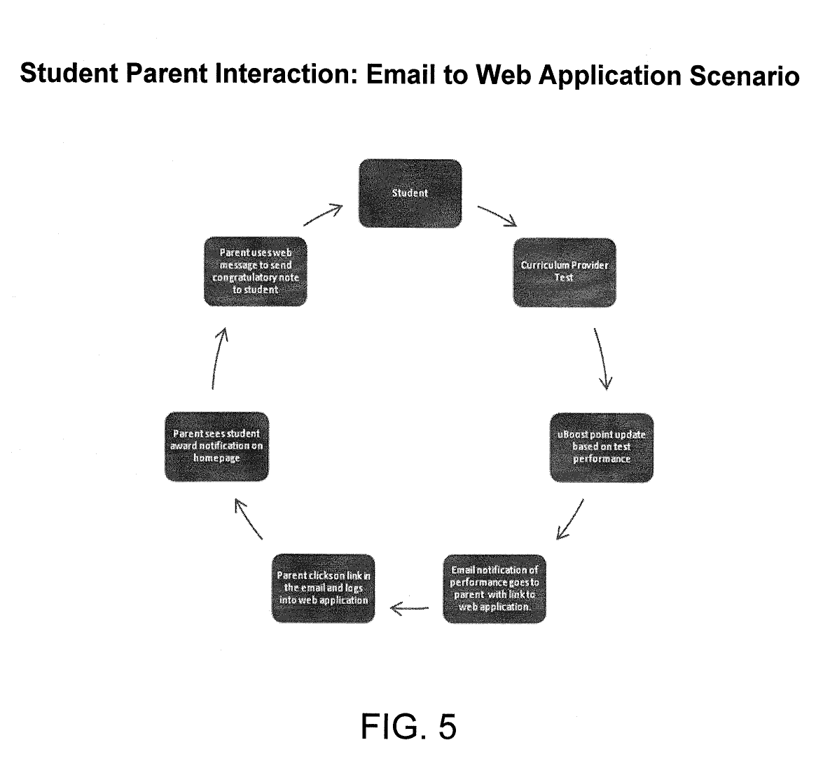

FIG. 5 shows the use case of the Student Parent Interaction: Email to Web Application Scenario:

(1) The Student takes a test provided by an External Curriculum Provider.

(2) After the Student completes the test, the curriculum provider's system automatically communicates performance information to the uBoost System using the uBoost web services API.

(3) The uBoost System updates the students point total based on the performance information.

(4) The uBoost System sends an email notification of the student's performance to the Parent's email address including a link to the web application page to view more details.

(5) After clicking on the link, the Parent is taken to the appropriate page on the uBoost website to view the details of the award notification on the homepage.

(6) The Parent can click on the “Send Note” link next to the notification message on the homepage and send a congratulatory message to the Student, which they can view in their web messages area on the uBoost website.

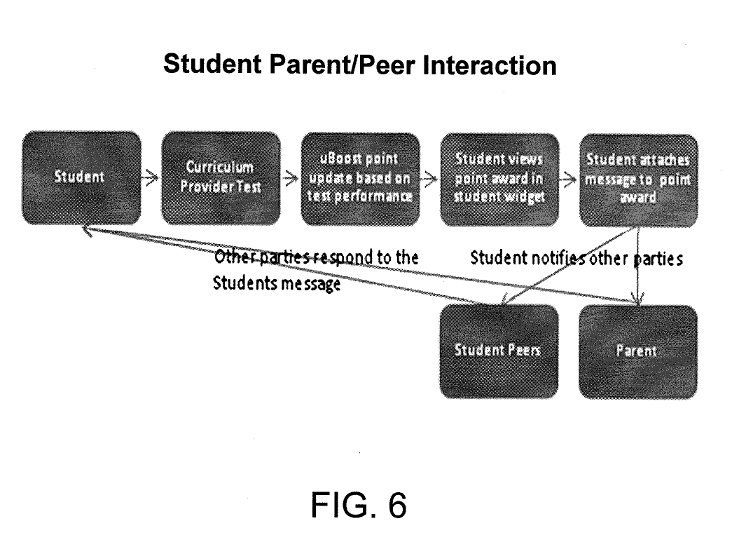

FIG. 6 shows the use case for Student ParentPeer interaction via web messaging:

(1) The Student takes a test provided by a curriculum provider.

(2) The website system updates the Student's points based on the test performance.

(3) The Student views their point awards via their student desktop widget or on their webpage.

(4) The Student can click to send a message regarding a point award such as to their Parent or to Student Peers.

(5) These parties may respond to the Student's message(s) by sending a message back which will appear in their Mailbox on their webpage and/or notified via their desktop widget.

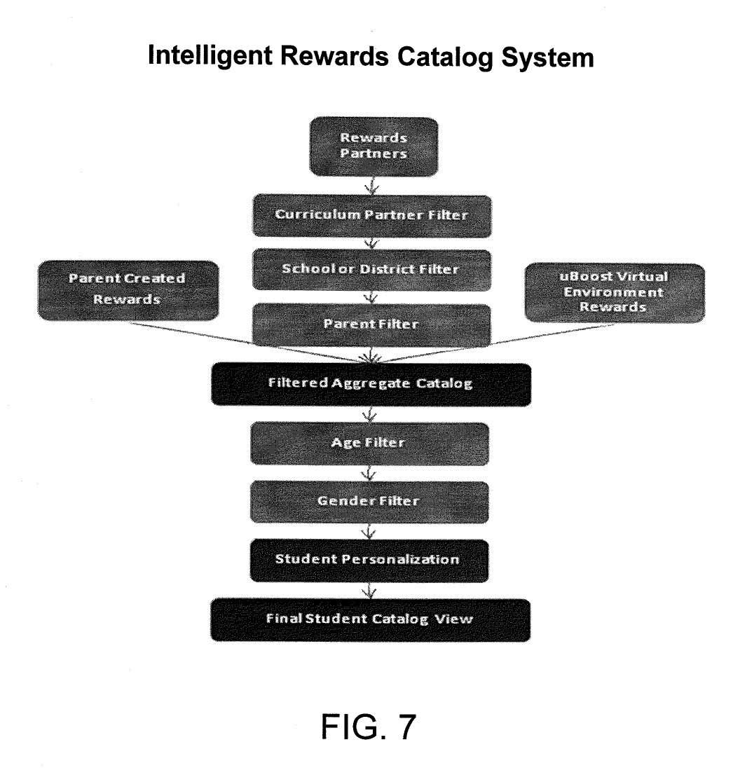

As an added feature of the educational website system, FIG. 7 shows an intelligent rewards catalog system for managing rewards offered by one or more rewards Partners. The intelligent rewards catalog system acts to automatically filter the inventory or inventories of offered rewards by the rewards Partner(s) based on parameters set by the relevant website participants. A curriculum partner filter may be applied to screen out rewards inconsistent with the values of the curriculum partner (Customer) providing the curriculum content offered on the website, e.g., screening out toys that are non-educational in value. A class, school or district filter may be applied to screen out rewards inconsistent with the policies of the school or district, e.g., clothing inconsistent with a school dress code, or snacks inconsistent with nutritional standards. A parent filter may be applied to screen out rewards inconsistent with the values of the Student's parent(s). In this manner, the rewards function for each Student can be personalized down to the individual Student level so as to maintain satisfaction with the participating Parent. The resulting filtered aggregate catalog may be further filtered for appropriate factors relating to the individual Student, such as age, gender, and any other relevant factor of Student personalization. The resulting final student catalog view will therefore offer as available only those rewards that are consistent with all participants in the educational website.

The catalog(s) may also offer digital (virtual) assets provided by the website operator and/or rewards partners for the purpose of enabling Students to make their webpages (virtual environment) more attractive. Examples include virtual furniture to decorate their webpage “room” and virtual interactive “pets” to keep them company. The system may also permit desired rewards that are not offered by the rewards Partner(s), to be added to the filtered aggregate catalog, such as Parent-created rewards and/or system virtual rewards.

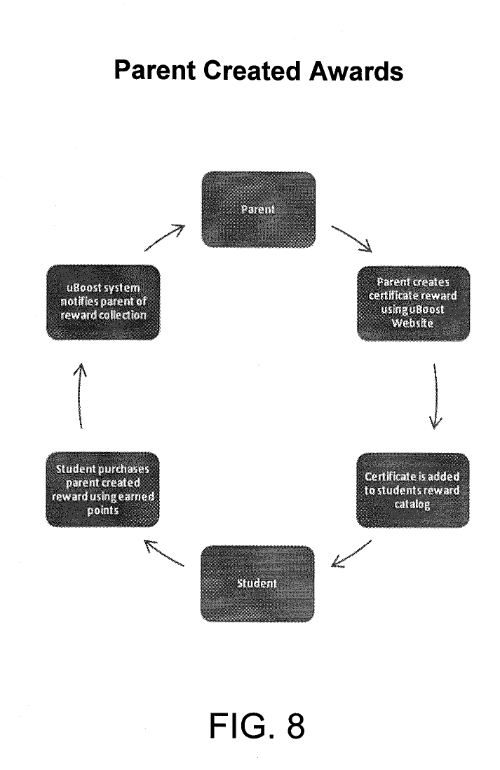

FIG. 8 illustrates the process for adding Parent-created rewards to the rewards catalog. A Parent can create an electronic display (recognition) certificate (or other desired) reward when logged on as a Parent User of the educational website. The certificate is added to the Student's reward catalog. Upon earning reward points, the Student may exchange or “purchase” the Parent-created certificate from the catalog of available rewards displayed to the Student. The system can then decrement the corresponding number of points and also notify the Parent that the certificate reward was claimed.

In summary, the educational website system of the present invention provides an engagement platform for web-based educational content that involves students with their teachers and parents. It augments online curriculum and other activities by providing and managing point awards that can be used to “purchase” items from a catalog which can be personalized to the individual student based upon filters set by the relevant participants. It also employs a variety of communication techniques to maintain involvement and satisfaction or parents and teachers with student activities on the website. The system can also integrate access to curriculum providers on other web sites, as well as manage awards offered by multiple rewards partners.

It is understood that many modifications and variations may be devised given the above description of the principles of the invention. It is intended that all such modifications and variations be considered as within the spirit and scope of this invention, as defined in the following claims.

1. An educational website system for operation in conjunction with a website on a network, comprising:
a website for enabling student users to engage with curriculum content provided by a curriculum content provider on the network which includes: a student webpage accessible to a student user on or through said website; a teacher webpage accessible to a teacher user for enabling the teacher user to track and manage engagement of student users with the curriculum content on the website; a class registration webpage for enabling a teacher user to register a plurality of student users constituting a class as authorized student users on the website; and a parent registration webpage for enabling a parent of an authorized student user registered by the teacher user to register as a parent contact for that student user on the website;
an awards scoring component operable in conjunction with said website for scoring engagement by an authorized individual student user with curriculum content on said website and awarding award points to the individual student user based on that student user's performance with the curriculum content; and
a communication component operable in conjunction with said website for communicating information about an individual student user's performance with the curriculum content to the teacher and to the parent contact for the individual student user, in order to promote parent and teacher involvement with students' activities on the website.

2. An educational website system according to claim 1, wherein said parent communication component includes a parent desktop widget for loading in a desktop environment of a computer used by the parent user for connection on the network.

3. An educational website system according to claim 1, wherein said parent communication component includes a website application for the parent user for enabling the parent user to access information about the individual student user's performance with the curriculum content on said website.

4. An educational website system according to claim 1, wherein said parent communication component includes email automatically generated by a website application and sent to the parent user containing information about the individual student user's performance with the curriculum content on said website.

5. An educational website system according to claim 2, wherein said parent desktop widget includes a link for readily accessing a parent contact webpage on said website.

6. An educational website system according to claim 2, wherein said parent desktop widget includes a function for generating a feedback message to the individual student user through the student webpage on said website.

7. An educational website system according to claim 1, wherein said student webpage includes a website application for enabling the student user to generate a message to the registered parent contact with information about the individual student user's performance with the curriculum content on said website.

8. An educational website system according to claim 1, wherein said website includes a website application for enabling the student user to generate a message to a peer student user through the student webpage on said website.

9. An educational website system according to claim 1, wherein said website includes a website application for generating a message to the teacher user for the class of a student user with information about the student user's performance with the curriculum content on said website.

10. An educational website system according to claim 1, wherein said website is enabled to present curriculum content from a plurality of curriculum content providers on or through said website.

11. An educational website system according to claim 1, further comprising an awards management component operable in conjunction with said website for enabling a student user to redeem award points awarded to student users for a reward offered by a rewards partner on said website.

12. An educational website system according to claim 11, wherein said awards management component enables a rewards partner to offer an inventory of rewards in a catalog for selection by a student user on said website.

13. An educational website system according to claim 12, wherein said awards management component enables a plurality of rewards partners to offer respective inventories of rewards in respective catalogs for selection by a student user on said website.

14. An educational website system according to claim 13, wherein said awards management component presents the catalogs of respective inventories of rewards of the rewards partners on separate tabs for selection by a student user on said website.

15. An educational website system according to claim 12, wherein said awards management component includes at least one filter component for enabling a partner participant on said website to filter out awards from the inventory of the awards partner based on the partner participant's filtering criteria.

16. An educational website system according to claim 15, wherein said awards management component applies a plurality of filter components of respective partner participants to generate a filtered aggregate catalog of awards for selection by a student user on said website.

17. An educational website system according to claim 15, wherein said awards management component includes at least one filter component from the group consisting of: a curriculum partner filter; a class, school or district filter; a parent filter; an age filter; a gender filter; and a student personalization filter.

18. An educational website system according to claim 17, wherein said awards management component enables the awards presented for selection by a student user to be personalized to that individual student user.

19. An educational website system according to claim 17, wherein said awards management component enables a parent-created award to be added to the awards offered for selection by a student user on said website.

20. An educational website system according to claim 19, wherein said parent-created award is an electronic display (recognition) certificate reward created by a parent user when logged on to said parent webpage on said website.
